(19) United States
(12) Patent Application Publication
(10) Pub. No.: US 2021/0181116 A1
(43) Pub. Date: Jun. 17, 2021

(54) ANALYTE ANALYSIS METHOD

(71) Applicant: HAMAMATSU PHOTONICS K.K., Hamamatsu-shi, Shizuoka (JP)

(72) Inventors: Kazuhiko FUJIWARA, Hamamatsu-shi, Shizuoka (JP); Yoshihiro MARUYAMA, Hamamatsu-shi, Shizuoka (JP)

(73) Assignee: HAMAMATSU PHOTONICS K.K., Hamamatsu-shi, Shizuoka (JP)

(21) Appl. No.: 17/263,175

(22) PCT Filed: Jul. 16, 2019
(86) PCT No.: PCT/JP2019/027948

§ 371 Date: Jan. 26, 2021

(30) Foreign Application Priority Data
Jul. 31, 2018 (JP) 2018-143931

(51) Int. Cl. G01N 21/65; G01N 21/77

(52) U.S. Cl. CPC G01N 21/658; G01N 21/77

(57) ABSTRACT

An analyte analysis method includes, in one example, a mixing step of mixing an analyte, a metal ion solution, and a reducing agent to prepare a mixture solution, a metal microstructure generation step of reducing metal ions in the mixture solution by reducing action of the reducing agent in the mixture solution to generate a metal microstructure on a support, and attaching the analyte or a substance derived from the analyte to the metal microstructure, a measurement step of irradiating the metal microstructure on the support with excitation light, and measuring a spectrum of Raman scattered light generated by the excitation light irradiation, and an analysis step of analyzing the analyte based on the spectrum of the Raman scattered light.

### TECHNICAL FIELD

The present disclosure relates to an analyte analysis method.

### BACKGROUND ART

As a method for analyzing an analyte, there has been known a method based on a spectrum of Raman scattered light generated by irradiating the analyte with excitation light. Since the Raman scattering spectrum reflects molecular vibrations of the analyte, it is possible to analyze the analyte based on the shape of the Raman scattering spectrum. However, in this analysis method, the Raman scattering efficiency is very small in general, and therefore, it is difficult to perform the analysis when an amount of analyte is very small. Accordingly, conventionally, the types of analytes that can be practically subjected to this analysis method have been limited to substances such as minerals and high density plastics.

Meanwhile, Surface Enhanced Raman Scattering (SERS) spectroscopy has a significantly improved Raman scattering efficiency, and is capable of high sensitivity measurement, and thus, it is expected to be capable of analyzing a low concentration sample and it attracts attention. In SERS spectroscopy, high intensity Raman scattered light can be generated from an analyte, in a case where two principal conditions are satisfied, that is, an enhanced electric field (photon field) is generated at a metal microstructure irradiated with excitation light (first condition), and the analyte constantly exists in the immediate vicinity of the metal microstructure at which the enhanced electric field arrives (second condition).

In order to efficiently satisfy the first condition, a technique including use of a metal microstructure array designed to have various shapes of nanometer-order size has been proposed, in this method, an analyte is analyzed by SERS spectroscopy by using a substrate (SERS substrate) having a surface provided with the metal microstructure array, and for example, dropping the analyte onto the SERS substrate. Further, there has been proposed another technique of using a dispersion liquid containing metal colloids (for example, silver colloid particles, gold colloid particles) dispersed therein, in this method, an analyte is analyzed by SERS spectroscopy by putting the analyte into the metal colloid dispersion liquid.

It is necessary to satisfy the above second condition to analyze the analyte by SERS spectroscopy, in the case of using the SERS substrate and also in the case of using the metal colloid dispersion liquid. That is, the enhanced electric field can be achieved in a spatially limited area depending on the metal microstructure, and in many cases, such area exists in a gap in the metal microstructure. Therefore, in order to efficiently generate SERS light by satisfying the second condition, the analyte needs to exist in the limited gap.

In order to satisfy the second condition, the analyte is required to have high affinity for the metal constituting the metal microstructure and to be easily adsorbed. However, even when the first condition is satisfied by using the SERS substrate with which an enhanced electric field can be efficiently generated, an analyte that has low affinity for the metal constituting the metal microstructure and is difficult to be adsorbed cannot enter the narrow gap in the metal microstructure, and the second condition cannot be satisfied, and thus, it is difficult to analyze the analyte by SERS spectroscopy.

In order to analyze an analyte by SERS spectroscopy with use of a SERS substrate or a metal colloid dispersion liquid, it is necessary to prepare the SERS substrate or the metal colloid dispersion liquid in advance. SERS light is efficiently generated particularly with silver (Ag), however, silver is easily oxidized. When an oxide film is formed on a surface of a silver microstructure on the SERS substrate or silver colloids at the time of spectroscopic measurement, it is not possible to efficiently analyze an analyte by SERS spectroscopy. Further, it is necessary to keep the SERS substrate or the metal colloids uncontaminated until spectroscopic measurement starts, and thus, it is not easy to handle these.

Patent Document 1 discloses an invention designed to solve the above-described problem of the conventional techniques. According to the invention disclosed in this document, it is possible to easily perform an analysis by highly efficient SERS spectroscopy.

### CITATION LIST

### Patent Literature

Patent Document 1: Japanese Patent Application Laid-Open Publication No. 2018-25431

### SUMMARY OF INVENTION

### Technical Problem

Although the invention disclosed in Patent Document 1 enables performing an analysis on an analyte easily by highly efficient SERS spectroscopy, the types of analytes that can be analyzed are limited.

An object of the present invention is to provide a method with which a greater number of types of analytes can be easily analyzed by highly efficient SERS spectroscopy.

### Solution to Problem

A first aspect of the present invention is an analyte analysis method. The analyte analysis method includes (1) a mixing step of mixing an analyte, a metal ion solution, and a reducing agent to prepare a mixture solution; (2) a metal microstructure generation step of reducing metal ions in the mixture solution by reducing action of the reducing agent in the mixture solution to generate a metal microstructure on a support, and attaching the analyte or a substance derived from the analyte to the metal microstructure; (3) a measurement step of irradiating the metal microstructure on the support with excitation light, and measuring a spectrum of Raman scattered light generated by the excitation light irradiation; and (4) an analysis step of analyzing the analyte based on the spectrum of the Raman scattered light.

A second aspect of the present invention is an analyte analysis method. The analyte analysis method includes (1) a mixing step of mixing a metal ion solution and a reducing agent to prepare a mixture solution; (2) a metal microstructure generation step of reducing metal ions in the mixture solution by reducing action of the reducing agent in the mixture solution to generate a metal microstructure on a support; (3) a second mixing step of, after the metal microstructure generation step, mixing an analyte and the mixture solution to prepare a second mixture solution; (4) an attachment step of attaching the analyte or a substance derived from the analyte to the metal microstructure on the support in the second mixture solution; (5) a measurement step of, after the attachment step, irradiating the metal microstructure on the support with excitation light, and measuring a spectrum of Raman scattered light generated by the excitation light irradiation; and (6) an analysis step of analyzing the analyte based on the spectrum of the Raman scattered light.

A third aspect of the present invention is an analyte analysis method. The analyte analysis method includes (1) a mixing step of mixing a metal ion solution and a reducing agent to prepare a mixture solution; (2) a metal microstructure generation step of reducing metal ions in the mixture solution by reducing action of the reducing agent in the mixture solution to generate a metal microstructure on a support; (3) a drying step of drying the metal microstructure on the support; (4) an attachment step of, after the drying step, attaching an analyte or a substance derived from the analyte to the metal microstructure on the support; (5) a measurement step of, after the attachment step, irradiating the metal microstructure on the support with excitation light, and measuring a spectrum of Raman scattered light generated by the excitation light irradiation; and (6) an analysis step of analyzing the analyte based on the spectrum of the Raman scattered light.

### Advantageous Effects of Invention

According to the aspects of the present invention, it is possible to easily analyze a greater number of types of analytes by highly efficient SERS spectroscopy.

### BRIEF DESCRIPTION OF DRAWINGS

FIG. 1 is a flowchart of an analyte analysis method according to a first embodiment.

FIG. 2 is a flowchart of an analyte analysis method according to a second embodiment.

FIG. 3 is a flowchart of an analyte analysis method according to a third embodiment.

FIG. 4 is a view showing an optical system of a microspectroscope 1 used for measuring a SERS light spectrum in a measurement step in each example.

FIG. 5 is a table showing samples used in the examples.

FIG. 6 is a view showing SERS light spectra obtained in the example 1.

FIG. 7 is a view showing SERS light spectra obtained in the examples 1 to 4.

FIG. 8 is a view showing SERS light spectra obtained in the examples 5 and 6.

FIG. 9 is a view showing SERS light spectra obtained in the examples 7 and 8.

FIG. 10 is a view showing a SERS light spectrum obtained in the example 9.

FIG. 11 is a view showing a SERS light spectrum obtained in the example 10.

FIG. 12 is a view showing SERS light spectra obtained in the example 11.

FIG. 13 is a view showing a SERS light spectrum obtained in the example 12.

### DESCRIPTION OF EMBODIMENTS

Hereinafter, embodiments for carrying out the present invention will be described in detail with reference to the accompanying drawings. In the description of the drawings, the same elements will be denoted by the same reference signs, without redundant description. The present invention is not limited to these examples.

An analyte analysis method according to an embodiment mixes a metal ion solution and a reducing agent to prepare a mixture solution, reduces metal ions in the mixture solution by reducing action of the reducing agent in the mixture solution to generate a metal microstructure on a support, and attaches an analyte or a substance derived from the analyte to the metal microstructure. Then, the method irradiates the metal microstructure on the support with excitation light, measures a spectrum of Raman scattered light generated by the excitation light irradiation, and analyzes the analyte based on the spectrum of the Raman scattered light. The following will describe analyte analysis methods according to first to third embodiments.

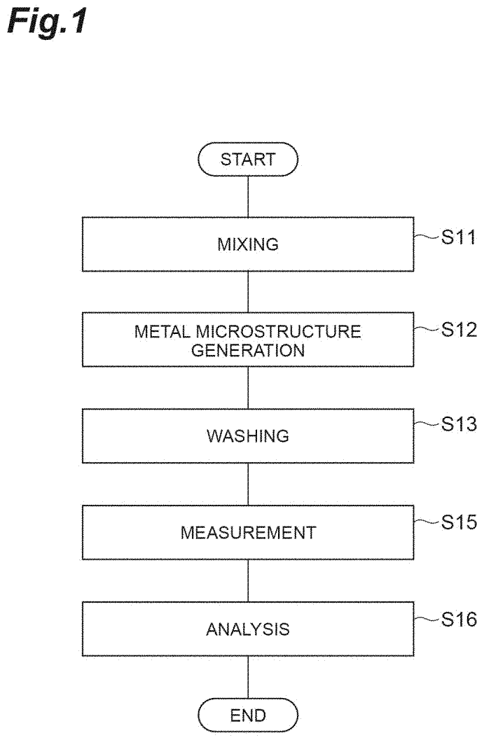

FIG. 1 is a flowchart of an analyte analysis method according to a first embodiment. The analyte analysis method of the first embodiment sequentially performs a mixing step S11, a metal microstructure generation step S12, a washing step S13, a measurement step S15, and an analysis step S16 to analyze an analyte. The analyte analysis method of the first embodiment prepares a mixture solution containing a measurement solution in the mixing step S11.

In the mixing step S11, a measurement solution containing an analyte, a metal ion solution, and a reducing agent are sufficiently mixed to prepare a mixture solution. In addition, a pH adjusting agent may be further mixed to prepare the mixture solution. The measurement solution, the metal ion solution, the reducing agent, and the pH adjusting agent can be mixed in various ways or in various orders. The measurement solution, the metal ion solution, the reducing agent, and the pH adjusting agent may be mixed at once. Further, the measurement solution, the metal ion solution, and the reducing agent may be mixed to prepare an intermediate mixture solution, and further, the intermediate mixture solution and the pH adjusting agent may be mixed to prepare a final mixture solution. Further, a salt may be further mixed to prepare the mixture solution. Further, after addition of the pH adjusting agent, the analyte may be added thereto even before the metal microstructure is completely generated.

The analyte may be any substance regardless of the presence or absence of reducing action, and examples include adenine, guanine, thymine, cytosine, and 4,4 [symbol] bipyridyl. The metal ion may be any substance reducible by the reducing action of the reducing agent, and examples include a gold ion and a silver ion. Examples of the reducing agent include an aqueous glucose solution, an aqueous iron(II) sulfate solution, an aqueous sodium borohydride solution, and an aqueous formaldehyde solution. The pH adjusting agent is added to make the mixture solution alkaline, and examples include an aqueous potassium hydroxide solution. The salt is added to promote aggregation of metal microparticles, and examples include sodium chloride. The amounts and concentrations of the metal ion solution, the reducing agent, and the pH adjusting agent mixed to prepare the final mixture solution are adjusted appropriately according to the amount of the measurement solution and the concentration of the analyte in the measurement solution.

In the metal microstructure generation step S12, the metal ions in the mixture solution are reduced by the reducing action of the reducing agent in the mixture solution so that the metal microstructure is generated on the support, and the analyte or a substance derived from the analyte is attached to the metal microstructure. The metal microstructure on the support is a structure in which aggregations of deposited metal microparticles are distributed on the support in the form of islands. In this step, for preventing evaporation of the mixture solution, the support is preferably allowed to stand still for a predetermined time in a humidified environment.

The support may be a container used in preparation of the intermediate mixture solution or the mixture solution, and further, the support may be a substrate prepared separately from the container, and the substrate may be, for example, a glass slide. Further, a glass slide subjected to a water repellent treatment with a predetermined pattern may be used, and the mixture solution may be prepared in a water non-repellent area of the glass slide to generate the metal microstructure. In the case where the substrate prepared separately from the container is used as the support, appropriate amounts of the intermediate mixture solution and the pH adjusting agent are dropped onto the substrate, and the intermediate mixture solution and the pH adjusting agent are sufficiently mixed on the substrate by use of, for example, a micropipette, so that a final mixture solution is prepared, and then, the metal microstructure is generated on the substrate.

In the washing step S13, an area on the support in which the metal microstructure is generated is washed with water (preferably, ultrapure water). By the washing, it is possible to remove the solution unnecessary for measurement in the measurement step S15, which will be performed later. In addition, depending on the sample, the washing step S13 may not be performed.

In the measurement step S15, the metal microstructure on the support is irradiated with excitation light, and a spectrum of Raman scattered light generated by the excitation light irradiation is measured. A measurement direction of the Raman scattered light with respect to an irradiation direction of the excitation light may be arbitrarily selected, any one of backward scattered light and forward scattered light may be measured, and scattered light in any other direction may be measured. Further, an optical filter designed to selectively transmit Raman scattered light is preferably provided in the middle of the measurement optical system. Preferably, the excitation light is laser light. An enhanced electric field is generated at the metal microstructure irradiated with the excitation light (first condition), and the analyte or the substance derived from the analyte is attached to the metal microstructure at which the enhanced electric field arrives (second condition), and thus, the measured Raman scattered light is SERS light generated from the analyte or the substance derived from the analyte.

In a case where a metal microstructure is generated in a narrow area on the support, it is preferable to perform the excitation light irradiation and measure the SERS light spectrum with use of a microspectroscope. The excitation light irradiation and measurement of the SERS light spectrum may be performed in a state where the area on the support in which the metal microstructure is generated is dry. In order to suppress burnout of the analyte or the substance derived from the analyte attached to the metal microstructure at the time of the excitation light irradiation, it is preferable to immerse the metal microstructure in a liquid (for example, water) on the support, and irradiate the immersed metal microstructure with the excitation light. In this case, a liquid immersion objective lens is preferably used as an objective lens.

In the analysis step S16, the analyte is analyzed based on the spectrum of the Raman scattered light (SERS light). Specifically, the analyte is analyzed based on the position of the Raman shift amount at which a peak appears and the height of the peak in the obtained SERS light spectrum.

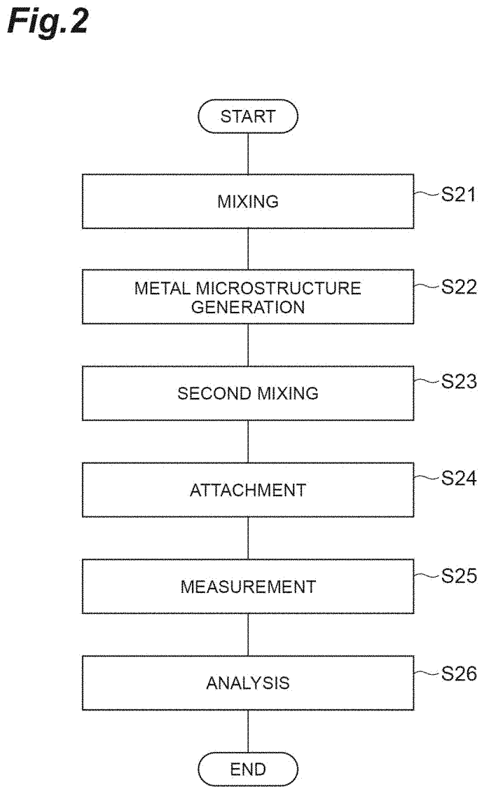

FIG. 2 is a flowchart of an analyte analysis method according to a second embodiment. The analyte analysis method of the second embodiment sequentially performs a mixing step S21, a metal microstructure generation step S22, a second mixing step S23, an attachment step S24, a measurement step S25, and an analysis step S26 to analyze an analyte. The analyte analysis method of the second embodiment prepares a second mixture solution, which is a mixture solution containing a measurement solution, in the second mixing step S23 after the metal microstructure generation step S22. The following will mainly described differences from the analyte analysis method of the first embodiment.

In the mixing step S21, a metal ion solution and a reducing agent are sufficiently mixed to prepare a mixture solution (intermediate mixture solution). In addition, a pH adjusting agent or a salt may be further mixed to prepare the mixture solution. In the mixing step S21, a measurement solution containing an analyte is not mixed in the mixture solution.

In the metal microstructure generation step S22, the metal ions in the mixture solution are reduced by the reducing action of the reducing agent in the mixture solution, so that a metal microstructure is generated on the support.

In the second mixing step S23, after the metal microstructure generation step S22, the measurement solution containing the analyte and the mixture solution are mixed to prepare a second mixture solution (final mixture solution). In addition, the mixture solution used in this step is a solution after generation of metal microparticles in the metal microstructure generation step S22, and therefore has a concentration different from that of the mixture solution obtained immediately after the mixing step S21.

In the attachment step S24, the analyte or a substance derived from the analyte is attached to the metal microstructure on the support in the second mixture solution. In addition, after the attachment step S24, an area on the support in which the metal microstructure is generated may be washed with water (preferably, ultrapure water).

The measurement step S25 in the second embodiment is identical to the measurement step S15 in the first embodiment. The analysis step S26 in the second embodiment is identical to the analysis step S16 in the first embodiment.

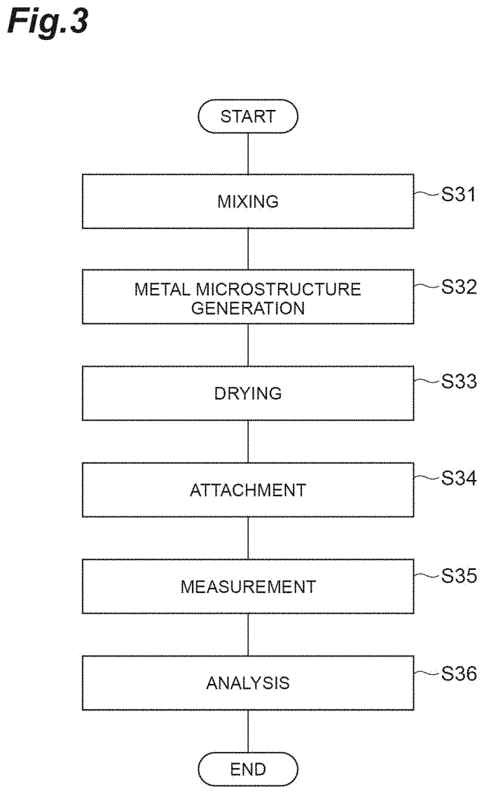

FIG. 3 is a flowchart of an analyte analysis method according to a third embodiment. The analyte analysis method of the third embodiment sequentially performs a mixing step S31, a metal microstructure generation step S32, a drying step S33, an attachment step S34, a measurement step S35, and an analysis step S36 to analyze an analyte. In the analyte analysis method of the third embodiment, in the attachment step S34 after the drying step S33, an analyte or a substance derived from the analyte is attached to a metal microstructure on a dry support. The following will mainly describe differences from the analyte analysis method of the second embodiment.

The mixing step S31 in the third embodiment is identical to the mixing step S21 in the second embodiment. The metal microstructure generation step S32 in the third embodiment is identical to the metal microstructure generation step S22 in the second embodiment.

In the drying step S33, the metal microstructure on the support is dried. In the attachment step S34, after the drying step S33, the analyte or the substance derived from the analyte is attached to the metal microstructure on the support.

The measurement step S35 in the third embodiment is identical to the measurement step S25 in the second embodiment. The analysis step S36 in the third embodiment is identical to the analysis step S26 in the second embodiment.

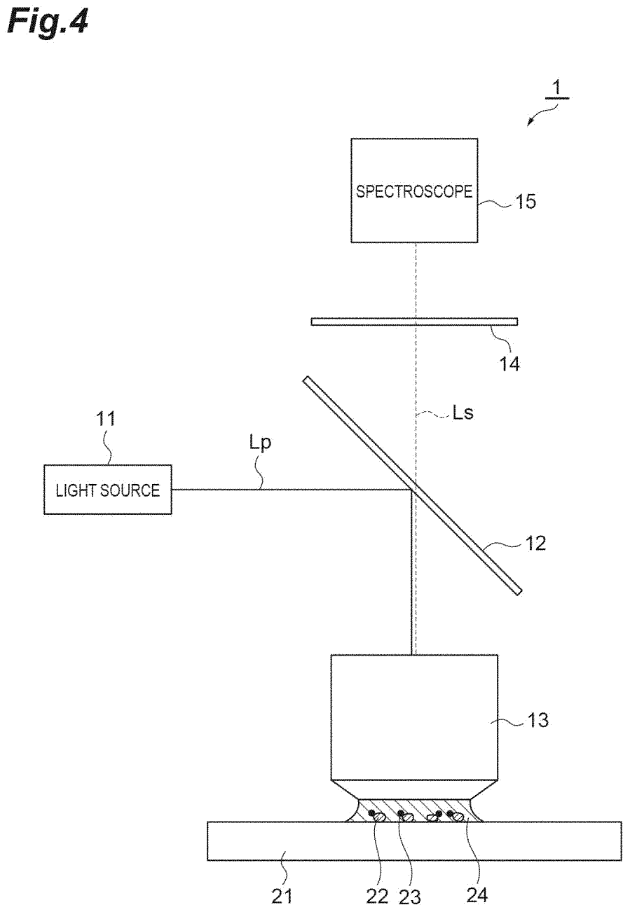

Next, examples 1 to 12 will be described. FIG. 4 is a view showing an optical system of a microspectroscope 1 used for measuring the SERS light spectrum in the measurement step in each example. In each example, a glass slide was used as the support for supporting the metal microstructure. On a surface of the support (glass slide) 21, a metal microstructure 22 in which aggregations of deposited metal microparticles were distributed in the form of islands was formed. To the metal microstructure 22, an analyte (or a substance derived from the analyte) 23 was attached. The metal microstructure 22 and the analyte 23 were immersed in water 24.

A He—Ne laser light source configured to output, as excitation light L_{P}, laser light having a wavelength of 632.8 nm was used as an excitation light source 11. The excitation light L_{P} output from the excitation light source 11 was reflected by a dichroic mirror 12, and then was transmitted through a water immersion objective lens 13 to irradiate the metal microstructure 22 and the analyte 23. The water immersion objective lens 13 had a magnification of 20× and a numerical aperture of 0.4. The power of the laser light with which the sample surface is irradiated through the water immersion objective lens 13 was 70 μW.

Raman scattered light (SERS light) Ls generated in response to the irradiation of the excitation light L_{P} and caught by the water immersion objective lens 13 entered a spectroscope 15 after passing through the dichroic mirror 12 and an optical filter 14. The spectroscope 15 includes a cooled CCD detector, and by the spectroscope 15, a spectrum of the SERS light was measured.

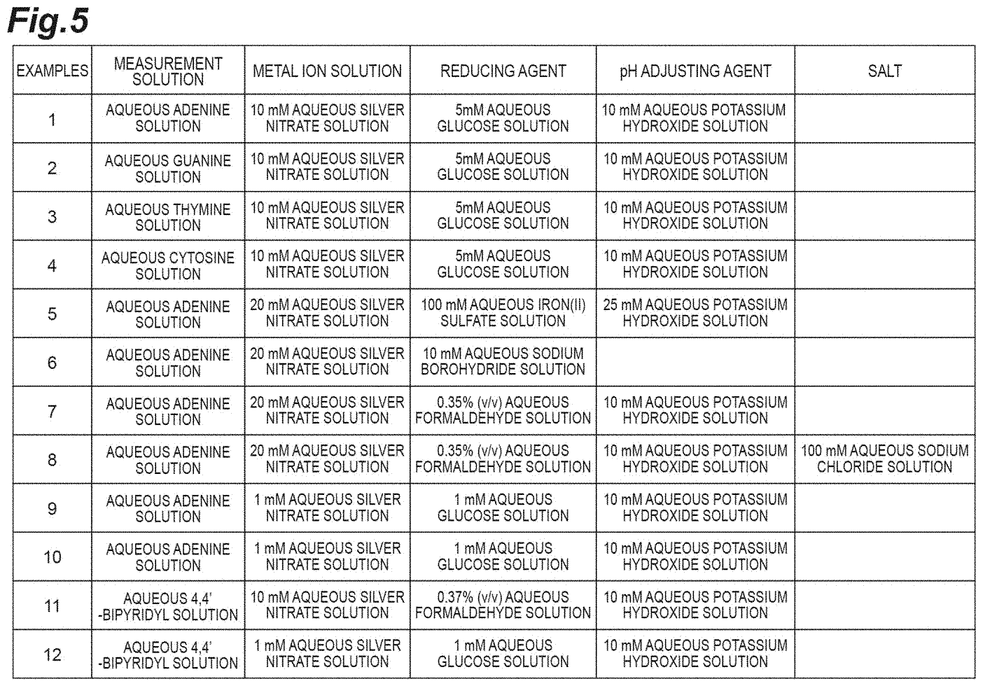

FIG. 5 is a table showing samples used in the examples. The examples 1 to 9 were performed according to the analyte analysis method of the first embodiment. The examples 10 to 12 were performed according to the analyte analysis method of the third embodiment.

In the examples 1 to 4, an aqueous silver nitrate solution (concentration 10 mM) was used as the metal ion solution, an aqueous glucose solution (concentration 5 mM) was used as the reducing agent, and an aqueous potassium hydroxide solution (concentration 10 mM) was used as the pH adjusting agent. In the example 1, aqueous adenine solutions (concentrations 0.12, 0.59, 1.17, 5.85, 11.7 μM) were used as the measurement solution containing the analyte. In the example 2, an aqueous guanine solution (concentration 24.5 μM) was used as the measurement solution containing the analyte. In the example 3, an aqueous thymine solution (concentration 38.9 μM) was used as the measurement solution containing the analyte. In the example 4, an aqueous cytosine solution (concentration 36.0 μM) was used as the measurement solution containing the analyte.

The examples 1 to 4 were performed with the procedures according to the flowchart shown in FIG. 1, as described below. In the mixing step S11, the measurement solution, the metal ion solution, and the pH adjusting agent were adjusted to respective predetermined concentrations. On the glass slide serving as the support, 10 μL of the metal ion solution was dropped, 5 μL of the measurement solution was further dropped onto the dropped spot, and these solutions were mixed on the glass slide. 5 μL of the reducing agent was further dropped onto the dropped spot, and these were mixed on the glass slide. Then, 5 μL of the pH adjusting agent was further dropped onto the dropped spot, and these were mixed on the glass slide to prepare the mixture solution.

In the metal microstructure generation step S12, the liquid droplet on the glass slide was allowed to stand still for an hour in a humidified environment, so that the metal ions were reduced by the reducing action of the reducing agent in the mixture solution and the metal microstructure was generated on the glass slide, and further, the analyte or the substance derived from the analyte was attached to the metal microstructure.

In the measurement step S15, the metal microstructure on the glass slide was irradiated with the excitation light (He—Ne laser light having a wavelength of 632.8 nm), and a spectrum of Raman scattered light (SERS light) generated by the excitation light irradiation was measured. In this step, the microspectroscope was used, and the metal microstructure was immersed in ultrapure water on the glass slide, and then, the immersed metal microstructure is irradiated with the excitation light through the water immersion objective lens.

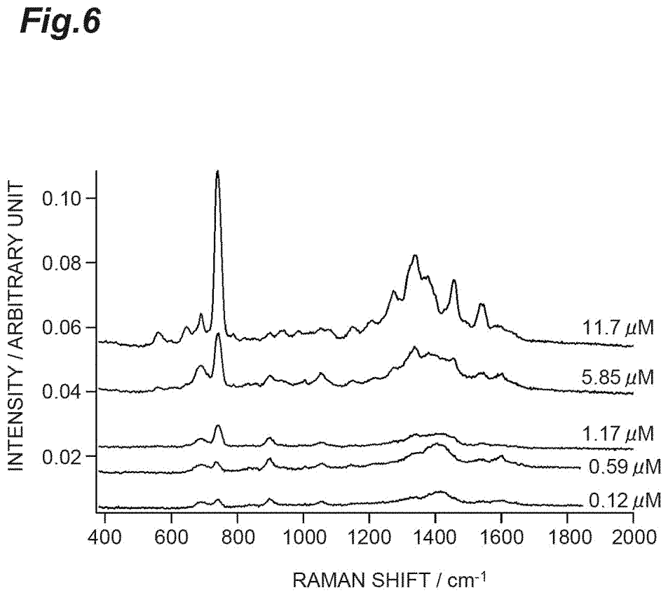

FIG. 6 is a view showing SERS light spectra obtained in the example 1. In this figure, the horizontal axis represents a Raman shift amount (unit cm⁻¹), and the vertical axis represents a Raman scattering intensity (arbitrary unit). Further, in this figure, the SERS light spectra have different zero points on the vertical axis. This also applies to the following drawings of SERS light spectra. As shown in this figure, peaks peculiar to adenine are clearly observed in the SERS light spectra, and the higher the concentration of adenine, the higher the peak value. From the peak values, it is possible to determine the quantities of the analytes.

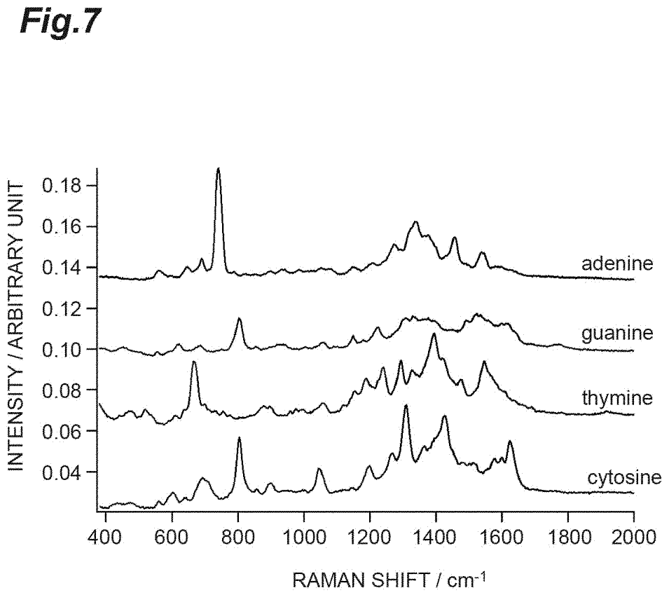

FIG. 7 is a view showing SERS light spectra obtained in the examples 1 to 4. In this figure, the concentration of adenine in the example 1 was 11.7 μM. As shown in this figure, depending on the structures of the analytes, the SERS light spectra have different shapes. Therefore, from the shape of the SERS light spectrum, it is possible to identify the analyte, and further, it is possible to determine an abundance ratio of compounds in the measurement solution. In addition, in general, without the enhanced effect, it is difficult to obtain the Raman spectra from the measurement solutions containing the analytes used in these examples, at the low concentrations as described above, meanwhile, according to the above method, it is possible to obtain the Raman spectra.

In the examples 5 and 6, an aqueous adenine solution (concentration 10 μM) was used as the measurement solution containing the analyte, and an aqueous silver nitrate solution (concentration 20 mM) was used as the metal ion solution. In the example 5, an aqueous iron(II) sulfate solution (concentration 100 mM) was used as the reducing agent, and an aqueous potassium hydroxide solution (concentration 25 mM) was used as the pH adjusting agent. In the example 6, an aqueous sodium borohydride solution (concentration 10 mM) was used as the reducing agent, and the pH adjusting agent was not used. The examples 5 and 6 were performed with the procedures identical to those of the examples 1 to 4. In addition, in the example 6, the pH adjusting agent was not mixed in the mixing step S11.

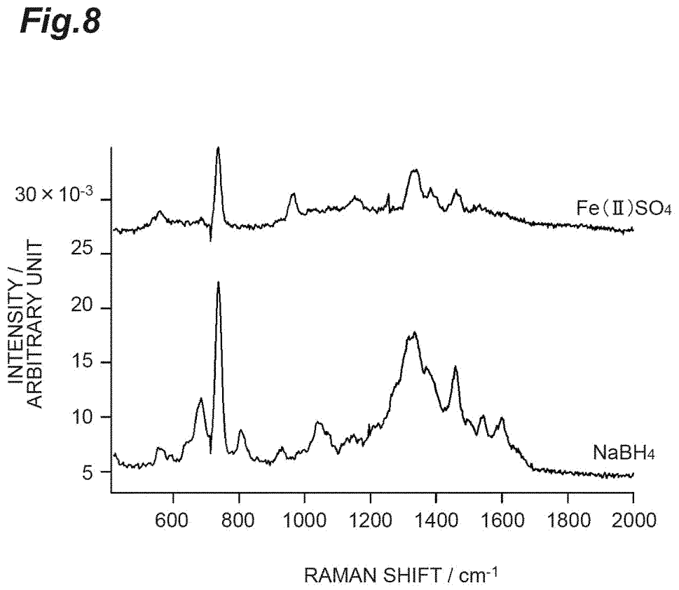

FIG. 8 is a view showing SERS light spectra obtained in the examples 5 and 6. As shown in this figure, in the cases where the aqueous iron(II) sulfate solution and the aqueous sodium borohydride solution were respectively used as the reducing agent, a silver microstructure was formed on the glass slide, and a peak peculiar to adenine is clearly observed in the SERS light spectrum.

In the examples 7 and 8, an aqueous adenine solution (concentration 10 μM) was used as the measurement solution containing the analyte, an aqueous silver nitrate solution (concentration 20 mM) was used as the metal ion solution, an aqueous formaldehyde solution (concentration 0.35% (v/v)) was used as the reducing agent, and an aqueous potassium hydroxide solution (concentration 10 mM) was used as the pH adjusting agent. In the example 8, an aqueous sodium chloride solution (concentration 100 mM) was further used as the salt. The examples 7 and 8 were performed with the procedures identical to those of the examples 1 to 4. In addition, in the example 8, after mixing of the pH adjusting agent, it was allowed to stand still for 30 minutes, and thereafter the salt was further mixed.

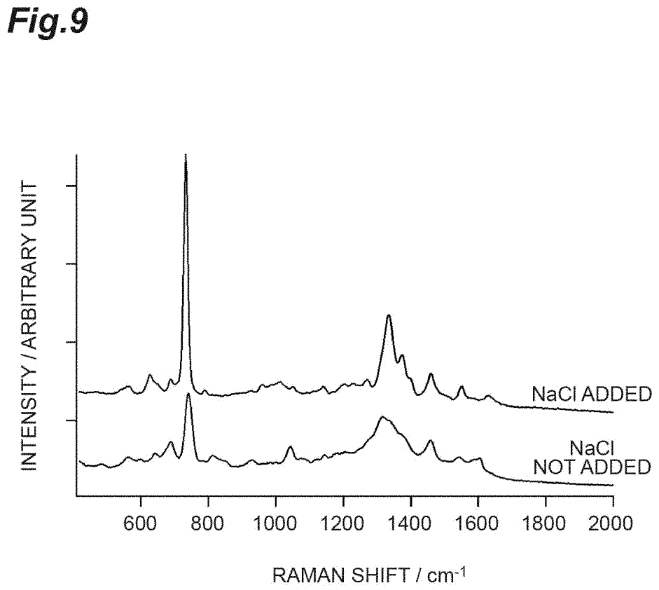

FIG. 9 is a view showing SERS light spectra obtained in the examples 7 and 8. As shown in this figure, in the case where sodium chloride was added, the peak peculiar to adenine in the SERS light spectrum is enhanced.

In the examples 9 and 10, an aqueous adenine solution (concentration 10 μM) was used as the measurement solution containing the analyte, an aqueous silver nitrate solution (concentration 1 mM) was used as the metal ion solution, an aqueous glucose solution (concentration 1 mM) was used as the reducing agent, and an aqueous potassium hydroxide solution (concentration 10 mM) was used as the pH adjusting agent. The example 9 was performed with the procedure according to the flowchart shown in FIG. 1, and identical to those of the examples 1 to 4.

The example 10 was performed with the procedure according to the flowchart shown in FIG. 3, as described below. In the mixing step S31, the metal ion solution and the pH adjusting agent were adjusted to respective predetermined concentrations. On the glass slide serving as the support, 10 μL of the metal ion solution was dropped, 5 μL of the reducing agent was further dropped onto the dropped spot, and these were mixed on the glass slide. Then, 5 μL of the pH adjusting agent was further dropped onto the dropped spot, and these were mixed on the glass slide to prepare the mixture solution.

In the metal microstructure generation step S32, the liquid droplet on the glass slide was allowed to stand still for an hour in a humidified environment, so that the metal ions were reduced by the reducing action of the reducing agent in the mixture solution and the metal microstructure was generated on the glass slide. After allowing it to stand still for an hour, in the drying step S33, the supernatant on the glass slide was removed, and the metal microstructure on the glass slide was dried. In the attachment step S34 thereafter, 5 μL of the measurement solution was dropped onto the metal microstructure on the glass slide, and the analyte or the substance derived from the analyte was attached to the metal microstructure.

In the measurement step S35, the metal microstructure on the glass slide was irradiated with excitation light (He—Ne laser light having a wavelength of 632.8 nm), and a spectrum of Raman scattered light (SERS light) generated by the excitation light irradiation was measured. In this step, the microspectroscope was used, and the metal microstructure was immersed in ultrapure water on the glass slide, and then, the immersed metal microstructure is irradiated with the excitation light through the water immersion objective lens.

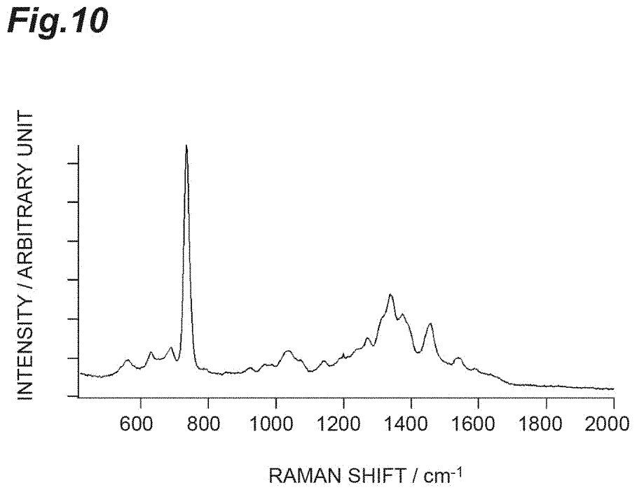

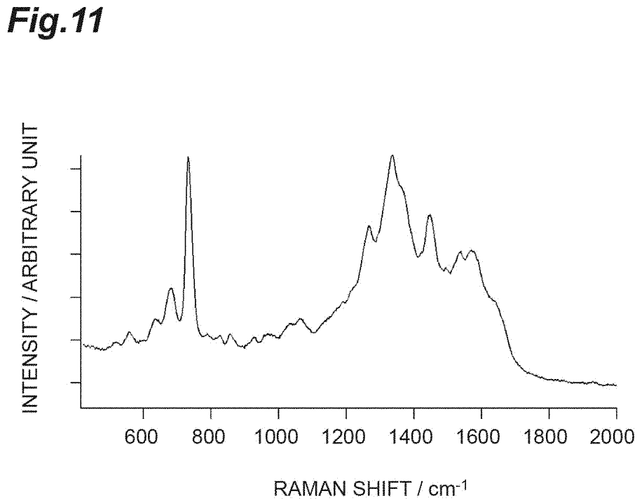

FIG. 10 is a view showing a SERS light spectrum obtained in the example 9. FIG. 11 is a view showing a SERS light spectrum obtained in the example 10. As shown in the figures, in the procedures respectively according to the flowcharts shown in FIG. 1 and FIG. 3, the peak peculiar to adenine is clearly observed in the SERS light spectrum. Further, the peak peculiar to adenine is observed more clearly in the procedure according to the flowchart shown in FIG. 1 than in the procedure according to the flowchart shown in FIG. 3.

In the example 11, aqueous 4,4′-bipyridyl solutions (concentrations 1, 10, 100 μM) were used as the measurement solution containing the analyte, an aqueous silver nitrate solution (concentration 10 mM) was used as the metal ion solution, an aqueous formaldehyde solution (concentration 0.37% (v/v)) was used as the reducing agent, and an aqueous potassium hydroxide solution (concentration 10 mM) was used as the pH adjusting agent. The example 11 was performed with the procedure according to the flowchart shown in FIG. 3, and identical to the procedure of the example 10. In addition, in the metal microstructure generation step S32, a time of still standing was set to 30 minutes.

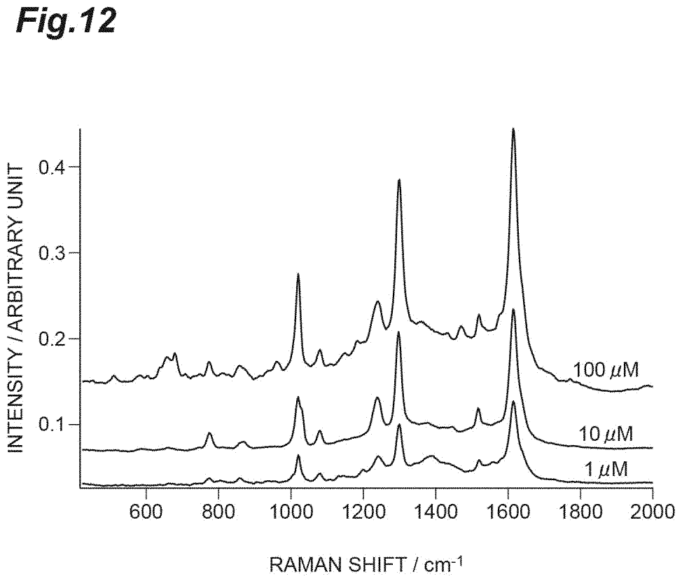

FIG. 12 is a view showing SERS light spectra obtained in the example 11. As shown in this figure, also in the case where the analyte is 4,4′-bipyridyl, peaks peculiar to 4,4′-bipyridyl are clearly observed in the SERS light spectra, and the higher the concentration of 4,4′-bipyridyl, the higher the peak value. From the peak values, it is possible to determine the quantities of the analytes.

In the example 12, an aqueous 4,4′-bipyridyl solution (concentration 10 μM) was used as the measurement solution containing the analyte, an aqueous silver nitrate solution (concentration 1 mM) was used as the metal ion solution, an aqueous glucose solution (concentration 1 mM) was used as the reducing agent, and an aqueous potassium hydroxide solution (concentration 10 mM) was used as the pH adjusting agent. In the example 12, the concentration of the metal ion solution was one-tenth of that of the example 11. The example 12 was performed with the procedure according to the flowchart shown in FIG. 3, and identical to the procedure of the example 10.

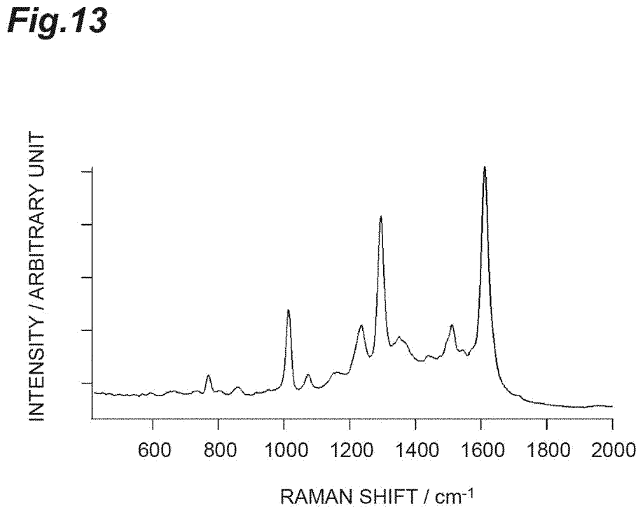

FIG. 13 is a view showing a SERS light spectrum obtained in the example 12. As shown in this figure, the peak peculiar to 4,4′-bipyridyl is clearly observed in the SERS light spectrum even with the metal ion solution whose concentration was one-tenth of that of the example 11.

As described above, the analyte analysis method of the present embodiment generates a metal microstructure on a support by reducing metal ions in a mixture solution by reducing action of a reducing agent in the mixture solution, attaches an analyte or a substance derived from the analyte to the metal microstructure, measures a spectrum of Raman scattered light (SERS light) generated by excitation light irradiation, and analyzes the analyte based on the spectrum. As compared to the conventional analysis method, the analyte analysis method of the present embodiment can perform the analysis easily and quickly.

In the conventional analysis method, the types of analytes that can be subjected to SERS spectroscopy are limited to substances that have high affinity for the metal constituting the metal microstructure and that are easy to be adsorbed. Further, in the invention disclosed in Patent Document 1, the types of analytes that can be subjected to SERS spectroscopy are limited to substances that have reducing action. In contrast, in the analyte analysis method of the present embodiment, it is possible to form a metal microstructure even with an analyte that has low affinity for the metal constituting the metal microstructure and that is difficult to be adsorbed or with an analyte that does not have reducing action, and the analyte or a substance derived from the analyte can enter a narrow gap in the metal microstructure, and thus the second condition can be satisfied, and this makes it possible to analyze the analyte by SERS spectroscopy.

In the conventional analysis method, it is necessary to prepare a SERS substrate or metal colloids in advance for performing SERS light spectrum measurement. In contrast, in the analyte analysis method of the present embodiment, it is possible to generate a metal microstructure and to attach an analyte (or a substance derived from the analyte) to the metal microstructure immediately before SERS light spectrum measurement. Therefore, in the analyte analysis method of the present embodiment, even in a case where silver, which is easily oxidized, is used to generate a metal microstructure, it is possible to suppress oxidization of silver, and to perform efficient SERS spectroscopy.

In the analyte analysis method of the present embodiment, it is not necessary to prepare the SERS substrate or metal colloids in advance, and therefore, it is free from the problem of contamination of these, thereby making it possible to easily analyze the analyte. Further, the analyte analysis method of the present embodiment uses the metal ion solution, which is available at a lower cost than the SERS substrate and metal colloids, and also for this reason, it is possible to easily analyze the analyte.

Further, in the conventional analysis method including use of a metal colloid dispersion liquid, it is difficult to perform SERS spectroscopy when an amount of analyte is very small. In contrast, in the analyte analysis method of the present embodiment, it is possible to perform SERS spectroscopy even when an amount of analyte is very small.

The present invention is not limited to the embodiments and configuration examples described above, and can be modified in various ways.

The first analyte analysis method of the above embodiments is configured to include (1) a mixing step of mixing an analyte, a metal ion solution, and a reducing agent to prepare a mixture solution; (2) a metal microstructure generation step of reducing metal ions in the mixture solution by reducing action of the reducing agent in the mixture solution to generate a metal microstructure on a support, and attaching the analyte or a substance derived from the analyte to the metal microstructure; (3) a measurement step of irradiating the metal microstructure on the support with excitation light, and measuring a spectrum of Raman scattered light generated by the excitation light irradiation; and (4) an analysis step of analyzing the analyte based on the spectrum of the Raman scattered light.

The second analyte analysis method of the above embodiments is configured to include (1) a mixing step of mixing a metal ion solution and a reducing agent to prepare a mixture solution (intermediate mixture solution); (2) a metal microstructure generation step of reducing metal ions in the mixture solution by reducing action of the reducing agent in the mixture solution to generate a metal microstructure on a support; (3) a second mixing step of, after the metal microstructure generation step, mixing an analyte and the mixture solution to prepare a second mixture solution; (4) an attachment step of attaching the analyte or a substance derived from the analyte to the metal microstructure on the support in the second mixture solution; (5) a measurement step of, after the attachment step, irradiating the metal microstructure on the support with excitation light, and measuring a spectrum of Raman scattered light generated by the excitation light irradiation; and (6) an analysis step of analyzing the analyte based on the spectrum of the Raman scattered light.

The third analyte analysis method of the above embodiments is configured to include (1) a mixing step of mixing a metal ion solution and a reducing agent to prepare a mixture solution; (2) a metal microstructure generation step of reducing metal ions in the mixture solution by reducing action of the reducing agent in the mixture solution to generate a metal microstructure on a support; (3) a drying step of drying the metal microstructure on the support; (4) an attachment step of, after the drying step, attaching an analyte or a substance derived from the analyte to the metal microstructure on the support; (5) a measurement step of, after the attachment step, irradiating the metal microstructure on the support with excitation light, and measuring a spectrum of Raman scattered light generated by the excitation light irradiation; and (6) an analysis step of analyzing the analyte based on the spectrum of the Raman scattered light.

In the above analyte analysis method, in the mixing step, a pH adjusting agent may be further mixed to prepare the mixture solution. Further, in the above analyte analysis method, in the mixing step, a salt may be further mixed to prepare the mixture solution.

In the above analyte analysis method, in the metal microstructure generation step, the metal microstructure may be generated on the support by allowing the support to stand still for a predetermined time in a humidified environment.

In the above analyte analysis method, in the measurement step, the metal microstructure may be immersed in a liquid on the support, and the immersed metal microstructure may be irradiated with the excitation light.

### INDUSTRIAL APPLICABILITY

The present invention is usable as an analyte analysis method capable of easily analyzing a greater number of types of analytes by highly efficient SERS spectroscopy.

### REFERENCE SIGNS LIST

1—microspectroscope, 11—excitation light source, 12—dichroic mirror, 13—water immersion objective lens, 14—optical filter, 15—spectroscope, 21—support, 22—metal microstructure, 23—analyte (or substance derived from analyte), 24—water.

1. An analyte analysis method comprising:
a mixing step of mixing an analyte, a metal ion solution, and a reducing agent to prepare a mixture solution;
a metal microstructure generation step of reducing metal ions in the mixture solution by reducing action of the reducing agent in the mixture solution to generate a metal microstructure on a support, and attaching the analyte or a substance derived from the analyte to the metal microstructure;
a measurement step of irradiating the metal microstructure on the support with excitation light, and measuring a spectrum of Raman scattered light generated by the excitation light irradiation; and
an analysis step of analyzing the analyte based on the spectrum of the Raman scattered light.

2. An analyte analysis method comprising:
a mixing step of mixing a metal ion solution and a reducing agent to prepare a mixture solution;
a metal microstructure generation step of reducing metal ions in the mixture solution by reducing action of the reducing agent in the mixture solution to generate a metal microstructure on a support;
a second mixing step of, after the metal microstructure generation step, mixing an analyte and the mixture solution to prepare a second mixture solution;
an attachment step of attaching the analyte or a substance derived from the analyte to the metal microstructure on the support in the second mixture solution;
a measurement step of, after the attachment step, irradiating the metal microstructure on the support with excitation light, and measuring a spectrum of Raman scattered light generated by the excitation light irradiation; and
an analysis step of analyzing the analyte based on the spectrum of the Raman scattered light.

3. An analyte analysis method comprising:
a mixing step of mixing a metal ion solution and a reducing agent to prepare a mixture solution;
a metal microstructure generation step of reducing metal ions in the mixture solution by reducing action of the reducing agent in the mixture solution to generate a metal microstructure on a support;
a drying step of drying the metal microstructure on the support;
an attachment step of, after the drying step, attaching an analyte or a substance derived from the analyte to the metal microstructure on the support;
a measurement step of, after the attachment step, irradiating the metal microstructure on the support with excitation light, and measuring a spectrum of Raman scattered light generated by the excitation light irradiation; and
an analysis step of analyzing the analyte based on the spectrum of the Raman scattered light.

4. The analyte analysis method according to claim 1, wherein, in the mixing step, a pH adjusting agent is further mixed to prepare the mixture solution.

5. The analyte analysis method according to claim 1, wherein, in the mixing step, a salt is further mixed to prepare the mixture solution.

6. The analyte analysis method according to claim 1, wherein, in the metal microstructure generation step, the metal microstructure is generated on the support by allowing the support to stand still for a predetermined time in a humidified environment.

7. The analyte analysis method according to claim 1, wherein, in the measurement step, the metal microstructure is immersed in a liquid on the support, and the immersed metal microstructure is irradiated with the excitation light.

8. The analyte analysis method according to claim 2, wherein, in the mixing step, a pH adjusting agent is further mixed to prepare the mixture solution.

9. The analyte analysis method according to claim 2, wherein, in the mixing step, a salt is further mixed to prepare the mixture solution.

10. The analyte analysis method according to claim 2, wherein, in the metal microstructure generation step, the metal microstructure is generated on the support by allowing the support to stand still for a predetermined time in a humidified environment.

11. The analyte analysis method according to claim 2, wherein, in the measurement step, the metal microstructure is immersed in a liquid on the support, and the immersed metal microstructure is irradiated with the excitation light.

12. The analyte analysis method according to claim 3, wherein, in the mixing step, a pH adjusting agent is further mixed to prepare the mixture solution.

13. The analyte analysis method according to claim 3, wherein, in the mixing step, a salt is further mixed to prepare the mixture solution.

14. The analyte analysis method according to claim 3, wherein, in the metal microstructure generation step, the metal microstructure is generated on the support by allowing the support to stand still for a predetermined time in a humidified environment.

15. The analyte analysis method according to claim 3, wherein, in the measurement step, the metal microstructure is immersed in a liquid on the support, and the immersed metal microstructure is irradiated with the excitation light.
